(19) United States
(12) Patent Application Publication
(10) Pub. No.: US 2005/0218367 A1
(43) Pub. Date: Oct. 6, 2005

(54) Control valve for inflatable structure

(75) Inventor: Neil Shinner, London (GB)

Correspondence Address: COHEN, PONTANI, LIEBERMAN & PAVANE, 551 Fifth Avenue, Suite 1210, New York, NY, 10176, US

(73) Assignee: Spin Master Limited

(21) Appl. No.: 11/087,316

(22) Filed: Mar. 23, 2005

(30) Foreign Application Priority Data
Mar. 25, 2004 (GB) 0406718.1

(51) Int. Cl. F16K 1/00

(52) U.S. Cl. 251/322

(57) ABSTRACT

A control vale for use with an inflatable structure to allow the sealing and opening of the structure for providing air to and removing air from the structure. The control valve includes an aperture defined by a wall which selectively receives a closure at a first location for selectively closing the valve when in position. The valve includes an actuator biased to a sealing position. When actuated, the actuator causes the opening of a passage to allow air to flow through the valve.

The invention to which this application relates is to an improvement in the provision of a valve of the type which is used to allow the controlled inflation and deflation of an inflatable structure such as, for example, an inflatable slide, inflatable mattress or the like.

The provision of valve control means to allow the controlled inflation and deflation by the input and departure of air from a cavity in an inflatable structure is well known.

In order to improve the speed of inflation it is known to provide a valve having a structure which comprises a closure member which is threadably engaged on a wall which surrounds and defines an aperture which passes from externally of the structure into the cavity and through which aperture air is allowed to flow during inflation or deflation.

In addition, in this structure it is also known to provide a sealing member, typically of a rubber or flexible sheet material, which sealing member is capable of being hingedly moved from a normal location at which same is forced against the inner edge of the wall to act as a sealing member on the aperture and a hinged open position in which the aperture is at least partially opened and air is allowed to pass through said aperture.

The provision of the sealing member and the closure serve, in effect, to provide a double seal, especially when the cavity is full of air and the structure is inflated, as the force of the air in the cavity tends to force the sealing member into a sealing position against the inner edge of the wall and hence close the aperture.

A problem which is experienced with this type of valve is that, while it is known to remove the closure and hence apply a movement force onto the sealing member and move the same inwardly of the cavity to open the aperture and allow the release of the air to deflate the structure, said operation is really only practicable when it is required that a large quantity of air is to leave the cavity at any given time as, once the sealing member is moved to the open position a relatively large passage is formed to allow air, which it should be noted, is under pressure in the cavity, to escape the cavity through the aperture. However on many occasions, it is desired that air is emitted from the cavity, not to provide the wholesale deflation of the structure for storage purposes but rather, to allow the level of inflation of the structure to be adjusted so that for example, if the structure is over inflated and is “too hard” it is desired to allow a controlled, relatively small, quantity of air to be removed from the cavity but not sufficient so as to cause full deflation of the structure.

This is a particular requirement when the structure, when inflated, is to be used for comfort purposes, such as for example, an inflatable mattress or chair, where the mattress, if over inflated, may be deemed to be too hard for the preferences of a particular person lying on the same.

The aim of the present invention is therefore to provide a valve structure which allows the controlled departure of some but not necessarily all of the air from the cavity of an inflatable structure.

In a first aspect of the invention, there is provided a control valve in connection with at least one cavity of an inflatable structure to allow the selective sealing and when open the passage of air to and from said at least one cavity, said control valve including an aperture defined by a wall, said wall selectively receiving a closure at a first location to selectively close the valve when in position and wherein the valve is provided with actuation means which are biased to a closed sealing position and, when actuated, cause the opening of a passage to allow a quantity of air to flow through the valve from the cavity for the duration of actuation.

In on embodiment the actuation means are provided in the closure member and when operated, allow the passage of air from the cavity to the external environment via a passage opened in the closure.

In a further embodiment the actuation means can be operated to allow the passage of air without the need to remove the closure from the valve.

In a preferred embodiment the valve includes at a second location a sealing member portion which is movable between a position in which the same contacts the wall to at least partially seal the aperture, and a position at which at least part of the sealing member is removed from contact with the wall to allow the passage of air through said aperture for deflation and/or inflation of the cavity. In one embodiment the actuation means when operated causes the movement of the sealing member to an at least partially open position.

Typically, the actuation means pass from a position externally of the control valve to inside the valve to contact with the sealing member.

Typically the part of the actuation means which is exposed externally of the valve, is operable by a person without having to remove the closure from the valve assembly.

Typically, the actuation means includes an inner member formed separately to or as an integral part of an externally mounted member, said inner member located within the valve and positioned such that movement of the actuation means, the inner member contacts with the sealing member to move the same to the open position. Typically, the movement to the open position is maintained for the duration of operation of the actuation means and, upon release of the actuation means, the same allows the sealing member to return to the closed position. Typically the actuation means are resiliently biased toward a position at which the sealing member is in a closed position.

In one embodiment, the passage of air from the cavity when the actuation means are operated, is achieved via a labyrinth passage which passes through the interior of the control valve and leaves through a cavity in either of the closure member or the actuation means to atmosphere. In one embodiment, the external actuation member is provided with a passage which, when the actuation means is operated, allows a passage for the flow of air to be achieved.

Typically, the actuation means includes a seal internally of the valve which, when the actuation means are not operated, acts as an airtight seal to prevent the passage of air from the cavity through the actuation means arrangement.

In one embodiment, the inner member has a portion for contact with the sealing member, said portion having a relatively flat surface whose area, is preferably greater than 50% of the area size of the sealing member so as to ensure that the sealing member is opened in a controlled manner and in a manner which reduces the risk of damage to the sealing member by the inner member.

In one embodiment, the actuation means is provided as an integral part of the control valve thereby ensuring that actuation of the same is achieved without affecting the integrity of the control valve assembly. Furthermore, the ability to allow the controlled release of air from the cavity, without the need for removal of the closure, ensures that air can be selectively released from the inflated cavity without automatically causing the deflation or significant deflation of the cavity.

The present invention therefore allows the degree of inflation of a cavity to be controlled in a manner not previously achievable as the air passage which is defined in the closure and/or actuation means, is restricted so as to act as a means for restricting the amount of air which can escape at any given period of time from the aperture and hence cavity.

Typically, the full deflation of the cavity is achieved in a conventional manner whereby the closure itself is removed in conjunction with the actuation means mounted in the closure member and the sealing member can then be manually moved by a finger or deflation pump member to fully open the sealing member whereupon the air can pass through the aperture at a significantly faster rate than is the case by use of the actuation means.

Specific embodiments of the invention are now described with reference to the accompanying drawings, wherein:—

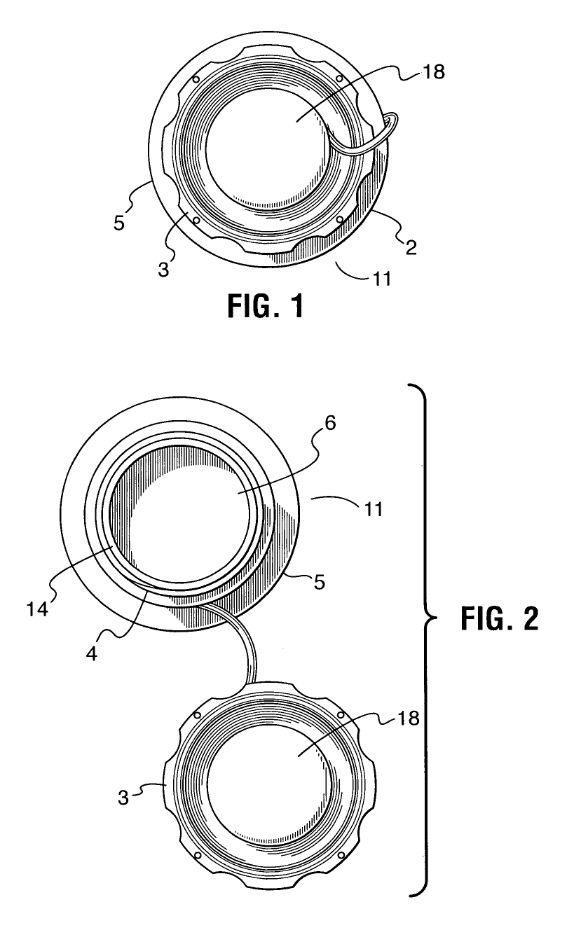

FIG. 1 illustrates an external plan view of an inflation and deflation control valve in accordance with one embodiment of the invention in a closed position;

FIG. 2 illustrates an external plan view of an inflation and deflation control valve in accordance with one embodiment of the invention in a full opened position;

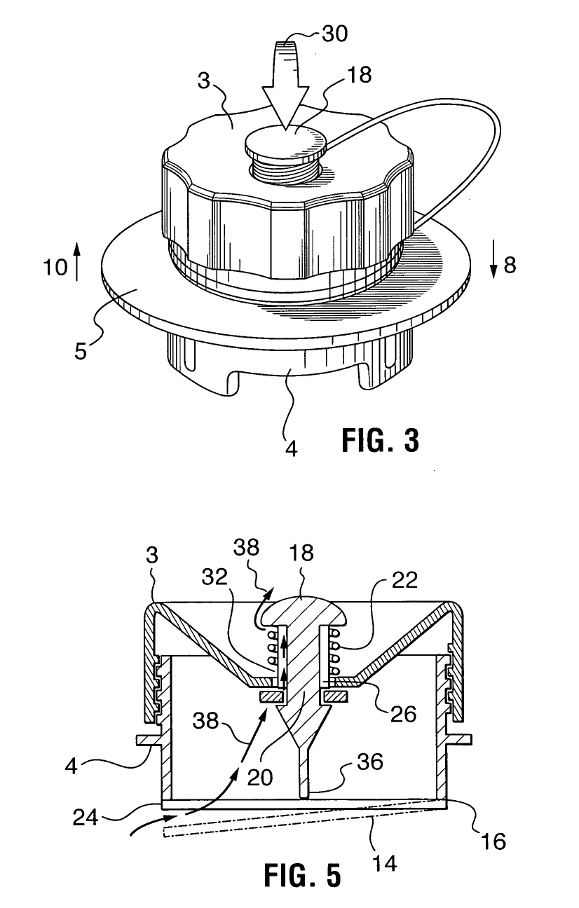

FIG. 3 illustrates perspective view of the control valve in a closed position;

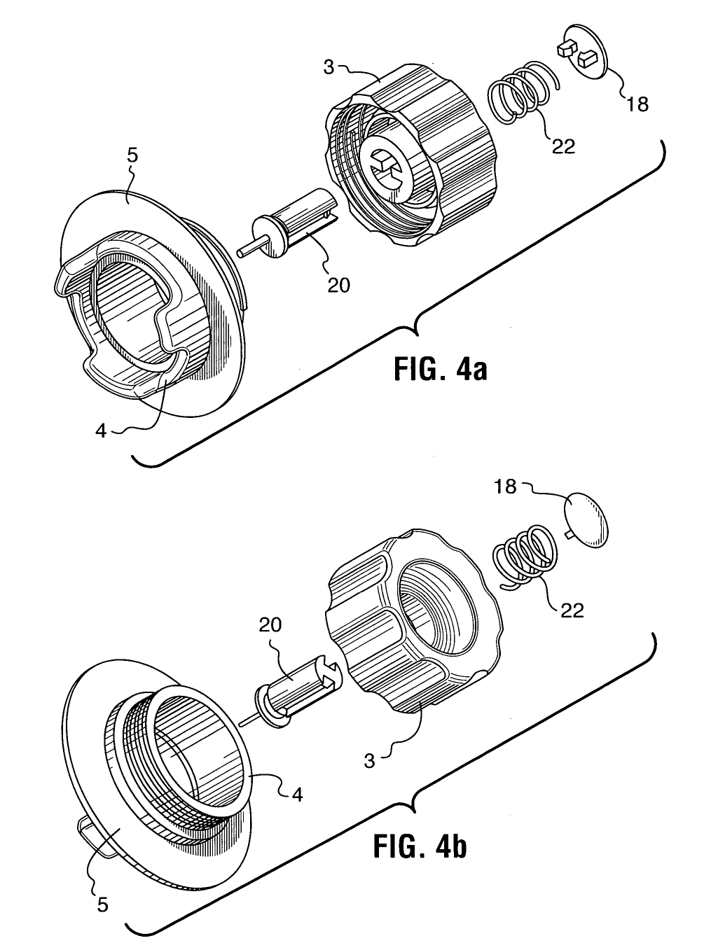

FIGS. 4a and b illustrate exploded perspective views of the components of the valve of FIG. 3;

FIG. 5 illustrates a detailed cross sectional view of the control valve of FIG. 3 in a normal, closed position; and

Referring firstly to FIGS. 1 and 2, there is illustrated an external view of a control valve 2 for use to allow the deflation or inflation of a cavity of an inflatable structure. The valve comprises an outer closure, 3, which is threadably engaged on an inner wall 4 on amounting 5. The wall is annular in cross section and defines an aperture 6 in which air, as shown in FIG. 3 can pass in direction 8 to allow inflation of a cavity and in direction 10 to allow deflation of the cavity 11 to the wall of which the valve is attached via mounting 5.

Also provided, on the inner side of the valve, i.e. lying within the cavity, is a sealing member 14, typically of a rubber or resilient plastic material. The sealing member is attached at at least one location 16 to the inner wall and is typically hingedly movable about that location with respect to the inner wall between a closed or sealing position and an open position with respect to the aperture. When the closure is removed as shown in FIG. 2 and the sealing member 14 moved to an open position the full passage of air is possible and the rapid inflation or deflation can be achieved. However, it will be appreciated by looking at the figure that the valve aperture is relatively large and therefore large quantities of air pass through the aperture quickly as it is obviously desired when inflating or fully deflating the structure that the same can be done as quickly as possible. However, this large flow of air is inconvenient when the user wishes to be able to simply adjust the level of inflation.

FIGS. 4a and b illustrate the components of the valve in accordance with the invention, with the exception of the sealing member 14 which is not shown. The Figures illustrate how the components are interengaged to form the closure with the actuation means fitted therein. As is further illustrated with reference to FIG. 5, the actuation means comprise an external member in the form of a cap 18 which is connected to an inner member 20. There is also provided a spring 22 between the cap and a lip on the inner member. Also mounted on the lip is a sealing member 24. In FIG. 5, the actuation means are shown in a closed position, i.e in a sealed position so that no air can pass therethrough from the cavity side 11 with the spring 22 acting to bias the actuation means to a normal closed and sealing position with the inner member 20 being forced by the spring into engagement with the washer 24 to seal the passage 26 to ensure that the integrity of the valve is maintained.

The actuation means can be moved to an open position to allow a relatively small quantity of air to escape from the cavity via the valve without the need to remove the closure by the depression of the part 18 and hence inner member in the direction of arrow 30 as indicated in FIG. 3. This causes the inner member to move downwardly and so the seal at the ring 24 is removed and so air is free to pass through the passage 26 and escape in the gap between the actuation means members 18,20 and the closure aperture 32 in which the same lies. The downward movement of the inner member also causes the free end 36 of the same to contact with the sealing member 14 and force the same to move to an at least partially opened position as indicated by the broken lines 14′ in FIG. 5 and therefore allow the flow of air in a bleed type quantity as indicated by arrows 38 to leave the cavity and pass through the control valve for as long as the actuation means are depressed.

In this manner, a controlled release of a relatively small quantity of air can be achieved and therefore allow the selective control of the level of inflation of the cavity of the inflatable structure.

Thus, in the example shown, the movement of the actuation means can be achieved by the simple depression of the external member 18 of the actuation means and the present invention therefore provides a valve which ensures that the required characteristics of relatively quick inflation and deflation of a cavity can be maintained while, at the same time, allowing the controlled deflation of smaller quantities of air from the cavity without the need of completely removing the valve to a fully deflating position.

It should also be appreciated that the valve can be used for purposes other than the passage of air and could be used for any gas and/or indeed fluid for control purposes in the same manner as herein described.

1. A control valve in connection with at least one cavity of an inflatable structure to allow the selective sealing and when open the passage of air to and from said at least one cavity, said control valve including an aperture defined by a wall, said wall selectively receiving a closure at a first location to selectively close the valve when in position and wherein the valve is provided with actuation means which are biased to a closed sealing position and, when actuated, cause the opening of a passage to allow a quantity of air to flow through the valve from the cavity for the duration of actuation.

2. A valve as claimed in claim 1, wherein said actuation means are provided in the closure member and when operated, allow the passage of air from the cavity to the external environment via a passage opened in the closure.

3. A valve as claimed in claim 2, wherein said actuation means can be operated to allow the passage of air without the need to remove the closure from the valve.

4. A valve as claimed in claim 3, including at a second location a sealing member portion which is movable between a position in which the same contacts the wall to at least partially seal the aperture, and a position at which at least part of the sealing member is removed from contact with the wall to allow the passage of air through said aperture for deflation and/or inflation of the cavity.

5. A valve as claimed in claim 4, wherein the actuation means when operated causes the movement of the sealing member to an at least partially open position.

6. A valve as claimed in claim 5, wherein said actuation means pass from a position externally of the control valve to inside the valve to contact with the sealing member.

7. A valve as claimed in claim 6, wherein said actuation means which is exposed externally of the valve, is operable by a person without having to remove the closure from the valve assembly.

8. A valve as claimed in claim 7, wherein said actuation means includes an inner member formed separately from or as an integral part of an externally mounted member, said inner member located within the valve and positioned such that movement of the actuation means, the inner member contacts with the sealing member to move the same to the open position, movement to the open position being maintained for the duration of operation of the actuation means and, upon release of the actuation means, the same allowing the sealing member to return to the closed position.

9. A valve as claimed in claim 8, wherein said actuation means are resiliently biased toward a position at which the sealing member is in a closed position.

10. A valve as claimed in claim 9, wherein said valve includes a labyrinth passage through the interior of the said valve and through a cavity in either of said closure member or said actuation means to the atmosphere.

11. A valve as claimed in claim 10, wherein said external actuation member is provided with a passage which, when the actuation means is operated, allows a passage for the flow of air to be achieved.

12. A valve as claimed in claim 11, wherein said actuation means includes a seal internally of the valve which, when the actuation means are not operated, acts as an airtight seal to prevent the passage of air from the cavity through the actuation means.

13. A valve as claimed in claim 8, wherein said inner member has a portion for contact with the sealing member, said portion having a relatively flat surface whose area is greater than about 50% of the area size of the sealing member thereby to ensure that the sealing member is opened in a controlled manner and in a manner which reduces the risk of damage to the sealing member by the inner member.

14. A valve as claimed in claim 2, wherein said actuation means is provided as an integral part of the control valve.
